(19) United States
(12) Patent Application Publication
(10) Pub. No.: US 2006/0198005 A1
(43) Pub. Date: Sep. 7, 2006

(54) Scanning unit and an image forming device comprising the same

(76) Inventor: Sang-hoon Lee, Sungnam-si (KR)

Correspondence Address: STANZIONE & KIM, LLP, 919 18TH STREET, N.W., SUITE 440, WASHINGTON, DC, 20006, US

(21) Appl. No.: 11/254,713

(22) Filed: Oct. 21, 2005

(30) Foreign Application Priority Data
Mar. 2, 2005 (KR) 2005-17336

(51) Int. Cl. G02B 26/08

(52) U.S. Cl. 359/216; 359/850; 359/212

(57) ABSTRACT

A scanning unit includes a casing, a polygon mirror assembly disposed in the casing, and a foam metallic material disposed in the casing to absorb a noise generated by the polygon mirror assembly. Thus, the scanning unit and an image forming device having the same can absorb and remove a noise generated by the polygon mirror assembly, thereby decreasing generation of the noise and a vibration thereof and enhancing a heat release from the laser scanning unit. Additionally, the image forming device may be made more compact, since a heat radiating fin is not necessary.

### CROSS-REFERENCE TO RELATED APPLICATIONS

This application claims the benefit under 35 U.S.C.§119 of Korean Patent Application No. 2005-17336, filed on Mar. 2, 2005, in the Korean Intellectual Property Office, the disclosure of which is incorporated herein in its entirety by reference.

### BACKGROUND OF THE INVENTION

1. Field of the Invention

The present general inventive concept relates to a scanning unit used in an image forming device, and more particularly, to a scanning unit having a foam metallic material and an image forming device comprising the same.

2. Description of the Related Art

In an image forming device, such as a printer, a copier, etc., a scanning unit that forms latent images on an OPC (opto photo-organic conductor) drum by scanning light on a surface thereof.

A conventional scanning unit using a laser beam is disclosed in Japanese Patent First Publication No. 2001-142023. FIG. 1 illustrates a conventional laser scanning unit 10 as disclosed by Japanese Publication No. 2001-142023. The conventional laser scanning unit 10 has a casing 11, a light source part 12 disposed in the casing 11, and a polygon mirror assembly 13. The polygon mirror assembly 13 has a polygon mirror 14 having polygon laterals, and a driving motor 15 to rotate the polygon mirror 14. A laser beam (not shown) generated by the light source part 12 is reflected by the rotating polygon mirror 14, and is then scanned to an OPC drum (not shown) located outside the conventional laser scanning unit 10.

The driving motor 15 rotates the polygon mirror 14 at a high speed, thereby generating noise and heat. Particularly, the polygon mirror 14 has a polygon-shaped plate which forms a strong vortex at an end part thereof while rotating. Therefore, the rotation of the polygon mirror 14 and the driving motor 15 have been a major cause of the noise generation.

In an attempt to solve the problem described above, the Japanese Publication (mentioned above) uses a cover member 16 made of aluminum materials surrounding a perimeter of the polygon mirror 14, thereby cutting off the noise. Both the cover member 16 and a heat radiation fin 17 provided at the driving motor 15 of the polygon mirror assembly 13 discharge the heat generated from the polygon mirror assembly 13 to an outside of the conventional light scanning unit 10.

However, the cover member 16 cannot absorb the noise generated from the polygon mirror assembly 13. The cover member 16 only insulates the noise. Therefore, the noise is still generated and resonates as a result of vibration of the cover member 16. Further, the aluminum used to make the cover member 16 has a low density, which provides inefficient noise insulation.

Further, the conventional laser scanning unit 10 has a size that is unnecessarily large, since the heat radiation fin 17 is projected outside of the conventional light scanning unit 10.

### SUMMARY OF THE INVENTION

The present general inventive concept provides a scanning unit and an image forming device comprising the same that can absorb and remove a noise generated by a polygon mirror assembly, thereby decreasing generation of the noise and a vibration thereof and enhancing a heat release from the scanning unit. The present general inventive concept also provides that the image forming device having the scanning unit can be made compact, since no heat radiating fin is necessary.

Additional aspects of the general inventive concept will be set forth in part in the description which follows and, in part, will be obvious from the description, or may be learned by practice of the general inventive concept.

The foregoing and/or other aspects of the present general inventive concept are achieved by providing a scanning unit, comprising a casing, a polygon mirror assembly disposed in the casing, and a foam metallic material disposed in the casing to absorb a noise generated by the polygon mirror assembly.

The foam metallic material may have a higher heat conductivity compared with the casing.

The foam metallic material may comprise aluminum.

The foam metallic material may be attached to an inner wall area of the casing.

The casing may comprise an opening, and the foam metallic material may be inserted in the opening such that a portion thereof is directly exposed to an outside of the scanning unit.

The foam metallic material may be shaped like a plate having a predetermined thickness.

The foam metallic material may be shaped like an array of a plurality of fins.

The foregoing and/or other aspects of the present general inventive concept are also achieved by providing a scanning unit usable with an electrophotographic image forming apparatus, the scanning unit comprising a casing, a light source disposed in the casing to generate a light beam, a movable reflector assembly disposed in the casing, a driving unit to drive the movable reflector assembly to reflect the light beam in one or more predetermined directions while generating at least one of a noise and a heat, and a porous conductive part disposed inside the casing to perform at least one of a noise reduction operation and a heat dissipation operation.

The foregoing and/or other aspects of the present general inventive concept are also achieved by providing an image forming device, comprising a scanning unit, the scanning unit including a casing, a polygon mirror assembly disposed in the casing, and a foam metallic material disposed in the casing to absorb a noise generated by the polygon mirror assembly.

The foregoing and/or other aspects of the present general inventive concept are also achieved by providing an electrophotographic image forming device, comprising a scanning unit to scan a light beam, the scanning unit including a housing, one or more moving parts disposed in the housing, and a metallic foam material disposed on an inner wall of the housing to reduce noise generated by the one or more moving parts and to dissipate heat from inside the housing.

### BRIEF DESCRIPTION OF THE DRAWINGS

These and/or other aspects of the present general inventive concept will become apparent and more readily appreciated from the following description of the embodiments, taken in conjunction with the accompany drawings of which:

FIG. 1 is a sectional view illustrating a conventional laser scanning unit;

FIG. 2 is a sectional view illustrating a laser beam printer according to an embodiment of the present general inventive concept;

FIG. 3 is a sectional view illustrating a laser scanning unit according to an embodiment of the present general inventive concept;

FIG. 4 is a plane view illustrating a polygon mirror assembly and a foam metallic material of the laser scanning unit of FIG. 3 according to an embodiment of the present general inventive concept;

FIG. 5 is a sectional view illustrating a laser scanning unit according to another embodiment of the present general inventive concept;

FIG. 6 is a bar chart illustrating a noise degree comparison between the laser scanning unit according to the embodiments of the present general inventive concept and the conventional laser scanning unit of FIG. 1; and

FIG. 7 is a graph illustrating a temperature comparison between the laser scanning unit according to the embodiments of the present general inventive concept and the conventional laser scanning unit of FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept while referring to the figures.

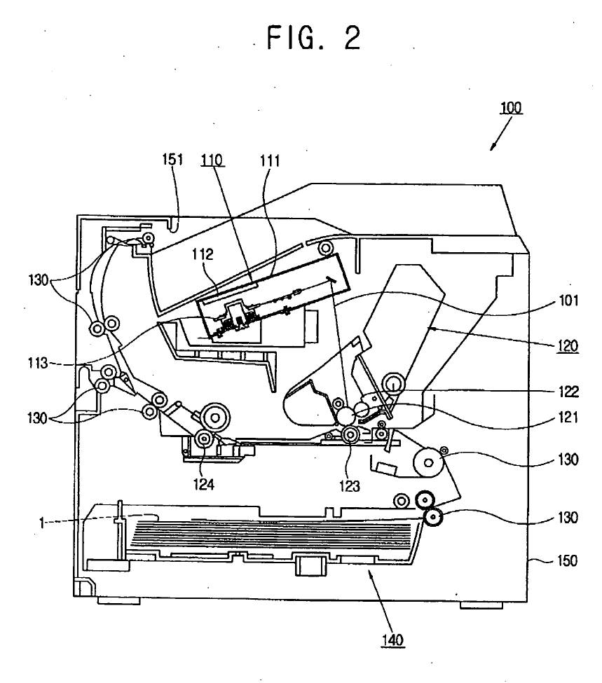

FIG. 2 is a sectional view illustrating a laser beam printer 100 according to an embodiment of the present general inventive concept. It should be understood that although the laser beam printer 100 is used to describe the various embodiments of the present general inventive concept, other types of image forming apparatuses may also be used with the present general inventive concept. Referring to FIG. 2, the laser beam printer 100 comprises a laser scanning unit 110 to scan a laser beam 101 according to an image signal, a developing unit 120 to receive the laser beam 101 from the laser scanning unit 110 and to form an image on a paper 1 supplied from a feed cassette 140, a plurality of rollers 130 to supply the paper 1 to the development unit 120 and to discharge the paper 1 on which the image is formed, and a housing 150 to contain the elements described above.

The laser beam 101 scanned from the laser scanning unit 110 forms latent images on a surface of an OPC drum 121 disposed in the development unit 120. A toner (not shown) distributed on a surface of a developing roller 122 is transferred to the latent images on the surface of the OPC drum 121 by an electrostatic force. The transferred toner is then transferred to the paper 1 in the form of an image by a transfer roller 123 to which a predetermined positive charge is applied. The toner is then heated and pressurized by a fix roller 124 and is fused onto the paper 1 to fix the transferred image. The rollers 130 discharge the paper 1 to which the toner is fused through an outlet 151 in the housing 150.

A foam metallic material 112 having aluminum is attached in an inner wall area of a casing 111 of the laser scanning unit 110. The foam metallic material 112 absorbs noise and dissipates heat generated by a polygon mirror assembly 113 arranged in the casing 111. Although the laser scanning units in the various embodiments of the present general inventive concept are described as having a polygon mirror assembly, it should be understood that other types of movable reflector assemblies may also be used with the present general inventive concept.

Unlike conventional laser beam printers, the laser beam printer 100 including the laser scanning unit 110 according to the present embodiment may operate silently and substantially without noise.

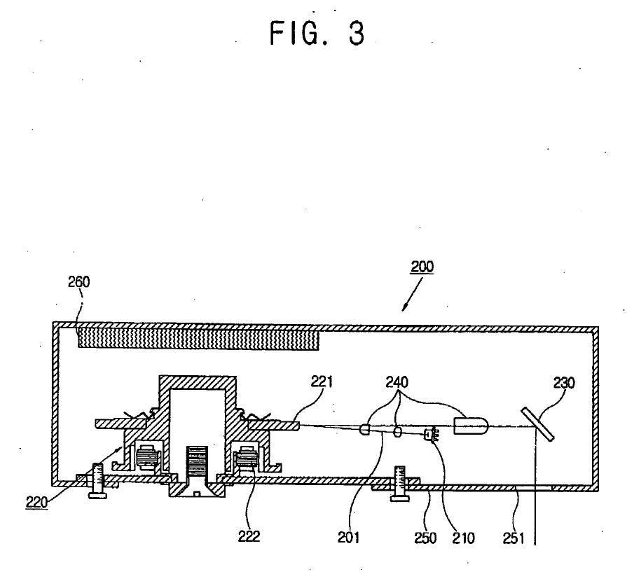

FIG. 3 is a sectional view illustrating a laser scanning unit 200 according to an embodiment of the present general inventive concept. Referring to FIG. 3, the laser scanning unit 200 comprises a laser diode 210 to discharge a laser beam 201 according to an image signal, a polygon mirror assembly 220 to reflect the laser beam 201 discharged from the laser diode 210, and a reflecting mirror 230 to reflect the laser beam 201 to an OPC drum (not shown) provided outside the laser scanning unit 200. The polygon mirror assembly 220 comprises a polygon mirror 221 to reflect the laser beam 201 and a driving motor 222 to rotate the polygon mirror 221.

Further, the laser scanning unit 200 comprises a plurality of lenses 240 mounted in an optical path of the laser beam 201, and a casing 250 to contain the elements described above. Accordingly, the laser beam 201 generated by the laser diode 210 is reflected by the polygon mirror 221, which is driven to rotate, and is again reflected by the reflecting mirror 230 to form latent images on a surface of the OPC drum (not shown) through a beam through hole 251 extending through a surface of the casing 250.

A foam metallic material 260 is mounted above the polygon mirror assembly 220, and is attached to an inner wall area of the casing 250. The foam metallic material 260 may comprise aluminum or an aluminum alloy, so that it absorbs and removes noise generated when the polygon mirror assembly 220 operates. The foam metallic material 260 transfers heat generated by the polygon mirror assembly 220 or heat generated inside of the laser scanning unit 200 to the casing 250, thereby easily discharging the generated heat outside of the laser scanning unit 200.

The foam metallic material 260 is a light material having a sponge shape, which can be obtained by melting and foaming aluminum or an aluminum alloy with some additives, so that a plurality of pores are formed therein. Therefore, when the noise generated by the polygon mirror assembly 220 (i.e., a sound wave) is transferred to the foam metallic material 260, the generated noise is converted to heat energy due to the plurality of the pores formed in the foam metallic material 260, thereby absorbing the noise.

The foam metallic material 260 also dissipates the heat generated in the laser scanning unit 200. Therefore, a heat conductivity of the foam metallic material 260 may be higher than that of the casing 250. The casing 250 of the laser scanning unit 200 may be made of steel or plastic, so that the foam metallic material 260 made of aluminum or an aluminum alloy has a higher heat conductivity compared with the casing 250.

Further, the foam metallic material 260 has the plurality of the pores formed therein, thereby having a wide surface area and enhancing convection. Therefore, the heat generated by the driving motor 222 and the polygon mirror 221, etc., is transferred to the foam metallic material 260 by convection, and is then transferred to the casing 250 therefrom by conduction, thereby easily discharging the generated heat outside of the laser scanning unit 200.

A weight of the foam metallic material 260 is less than about 1/10 of the same volume of aluminum metallic material, and is less than about 1/30 of the same volume of iron due to the plurality of the pores formed in the foam metallic material 260. Thus, the foam metallic material 260 can absorb the noise and dissipate the heat without significantly affecting an overall weight of the laser scanning unit 200. That is, the foam metallic material 260 does not add a large amount of weight to the laser scanning unit 200.

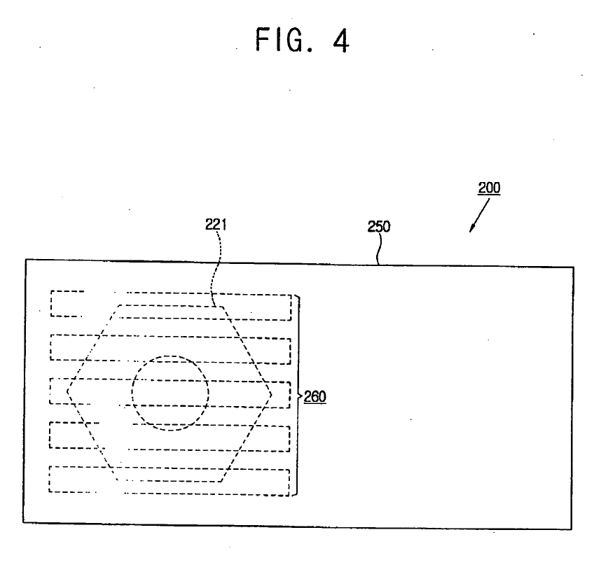

FIG. 4 is a plane view illustrating the polygon mirror assembly 220 and the foam metallic material 260 of the laser scanning unit 200 of FIG. 3 according to an embodiment of the present general inventive concept. Referring to FIG. 4, the foam metallic material 260 may have a shape of an array of a plurality of fins so as to enhance a release of the heat generated in the laser scanning unit 200. However, it should be understood that the foam metallic material 260 may have other shapes. For example, the foam metallic material 260 may be shaped like a single plate having a predetermined thickness.

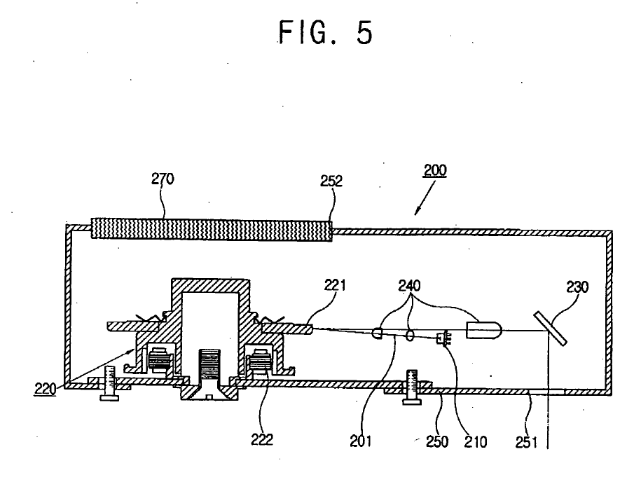

FIG. 5 is a sectional view illustrating the laser scanning unit 200 according to anther embodiment of the present general inventive concept.

Referring to FIG. 5, the casing 250 is formed with an opening 252 and a foam metallic material 270 may be inserted in the opening 252 so as to enhance the heat dissipation in the laser scanning unit 200. The foam metallic material 270 is exposed both inside and outside of the casing 250. Generally, the foam metallic material 270 has a higher heat conductivity than the casing 250, thereby discharging heat generated by the polygon mirror assembly 220 more efficiently. Particularly, the foam metallic material 270 may be substantially more efficient when the casing 250 is made of material, such as plastic, having a low heat conductivity.

The laser scanning unit 200 comprising the foam metallic material 260 and 270 has a function of noise absorption and heat dissipation due to the foam metallic material, 112, 260, and 270. Additionally, the foam metallic material 112, 260, and 270 cuts off the noise within the casing 250, thereby enhancing silence and stability during operation.

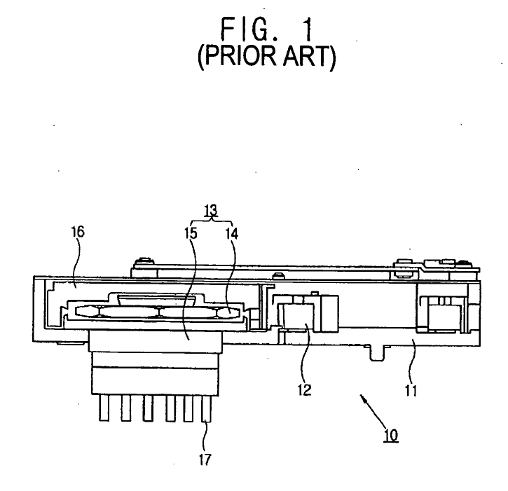

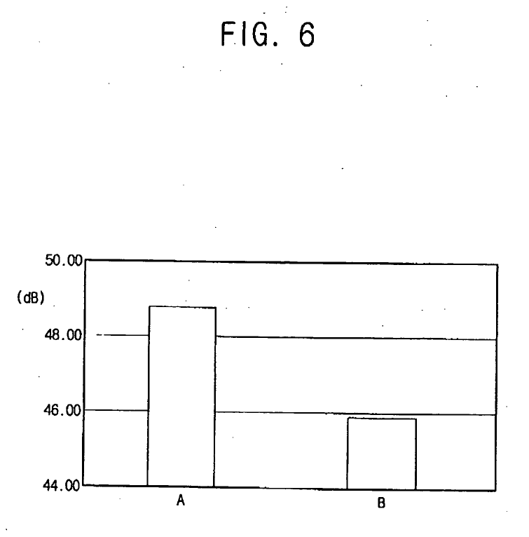

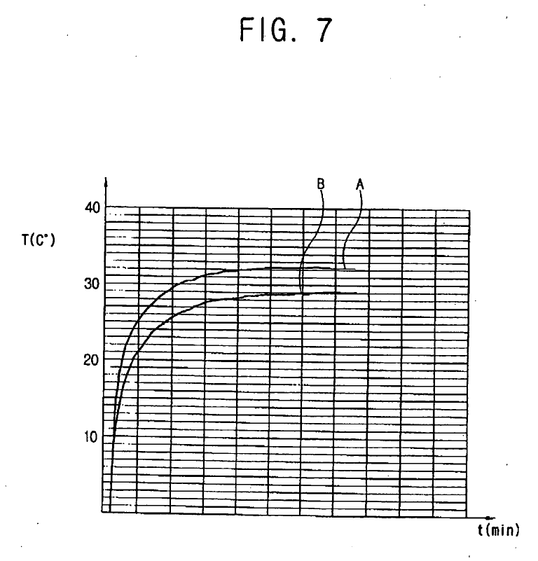

FIG. 6 is a bar chart illustrating a noise degree comparison between the laser scanning unit 110 and 200 according to the embodiments of the present general inventive concept and the conventional laser scanning unit 10 of FIG. 1. FIG. 7 is a graph illustrating a temperature comparison between the laser scanning unit 110 and 200 according to the embodiments of the present general inventive concept and the conventional laser scanning unit 10 of FIG. 1. The foam metallic material 112, 260, and 270 may be a pad having a 5 cm×5 cm area and a 5 mm thickness, and is attached in the inner wall area of the casing 111 and 250, which may be made of steel. A rotation speed of the polygon mirror 221 may be 36,500 rpm.

Referring to FIG. 6, a noise (B) of the laser scanning unit 110 and 200 using the foam metallic material 112, 260, and 270 is about 46 dB, which is less than noise (A) of the conventional laser scanning unit 10 (about 49 dB) by about 3 dB. Further, referring to FIG. 7, an inner temperature (B) of the laser scanning unit 110 and 200 using the foam metallic material 112, 260, and 270 is lower than that of the conventional laser scanning unit 10 by about 4 degrees Celsius.

The various embodiments of the present general inventive concept that use the foam metallic material 112, 260, and 270 may be applied to any scanning unit and/or any image forming device having the same. For example, the foam metallic material 112, 260, and 270 may be applied to a scanning unit that uses an LED (light emitting diode) as a light source. Further, the various embodiments of the present general inventive concept may be applied to a copier, a multi-function printer, a fax, etc. or other image forming devices that use a light source.

As described above, the various embodiments of the present general inventive concept provide a scanning unit and an image forming device comprising the same that can absorb and remove noise generated by a polygon mirror assembly, thereby decreasing generation of the noise and a vibration thereof. Further, the embodiments of the present general inventive concept use a foam metallic material having a high heat conductivity, thereby enhancing heat dissipation and reducing an overall size of the image forming device.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A scanning unit, comprising:
a casing;
a polygon mirror assembly disposed in the casing; and
a foam metallic material disposed in the casing to absorb a noise generated by the polygon mirror assembly.

2. The scanning unit according to claim 1, wherein the foam metallic material has a higher heat conductivity compared with the casing.

3. The scanning unit according to claim 2, wherein the foam metallic material comprises aluminum.

4. The scanning unit according to claim 2, wherein the foam metallic material is attached to an inner wall area of the casing.

5. The scanning unit according to claim 2, wherein the casing comprises an opening, and the foam metallic material is inserted in the opening such that a portion of the foam metallic material is directly exposed to an outside of the scanning unit.

6. The scanning unit according to claim 2, wherein the foam metallic material has a shape of a plate having a predetermined thickness.

7. The scanning unit according to claim 2, wherein the foam metallic material has a shape of an array of a plurality of fins.

8. The scanning unit according to claim 1, wherein the foam metallic material comprises aluminum.

9. The scanning unit according to claim 1, wherein the foam metallic material is attached to an inner wall area of the casing.

10. The scanning unit according to claim 1, wherein the casing comprises an opening, and the foam metallic material is inserted in the opening such that a portion of the foam metallic material is directly exposed to an outside of the scanning unit.

11. The scanning unit according to claim 1, wherein the foam metallic material has a shape of a plate having a predetermined thickness.

12. The scanning unit according to claim 1, wherein the foam metallic material has a shape of an array of a plurality of fins.

13. The scanning unit according to claim 1, wherein the foam metallic material dissipates heat from an interior of the scanning unit and a heat radiating fin is not included in the scanning unit.

14. The scanning unit according to claim 1, wherein the foam metallic material is separated from the polygon mirror assembly by a predetermined distance.

15. A scanning unit usable with an electrophotographic image forming apparatus, the scanning unit comprising:
a casing;
a light source disposed in the casing to generate a light beam;
a movable reflector assembly disposed in the casing;
a driving unit to drive the movable reflector assembly to reflect the light beam in one or more predetermined directions while generating at least one of a noise and a heat; and
a porous conductive part disposed inside the casing to perform at least one of a noise reduction operation and a heat dissipation operation.

16. The scanning unit according to claim 15, wherein the porous conductive part is disposed to be spaced apart from the movable reflector assembly and the driving unit.

17. The scanning unit according to claim 15, wherein the porous conductive part has a sponge-like shape.

18. The scanning unit according to claim 15, wherein the porous conductive part is disposed on an inner wall of the casing, and has a predetermined volume and a large surface area relative to the predetermined volume such that heat generated by the driving unit and the movable reflector assembly is transferred to the porous conductive part by convection.

19. The scanning unit according to claim 15, wherein the porous conductive part has a higher heat conductivity than the casing.

20. The scanning unit according to claim 15, wherein the porous conductive part comprises one of a foamy aluminum material and a foamy aluminum alloy material.

21. The scanning unit according to claim 15, wherein the casing includes an opening in which the porous conductive part is disposed such that a portion thereof is exposed outside the casing.

22. The scanning unit according to claim 15, wherein the porous conductive part comprises one of a flat rectangular shape and a flat rectangular shape with a plurality of fins.

23. The scanning unit according to claim 15, wherein noise energy generated by the driving unit and the movable reflective assembly is converted to heat energy by the porous conductive material and is passed to the casing to be dissipated therefrom.

24. An image forming device, comprising:
a scanning unit, the scanning unit including:
a casing;
a polygon mirror assembly disposed in the casing; and
a foam metallic material disposed in the casing to absorb a noise generated by the polygon mirror assembly.

25. The image forming device according to claim 24, wherein the foam metallic material has a higher heat conductivity compared with the casing.

26. An electrophotographic image forming device, comprising:
a scanning unit to scan a light beam, the scanning unit including:
a housing;
one or more moving parts disposed in the housing; and
a metallic foam material disposed on an inner wall of the housing to reduce noise generated by the one or more moving parts and to dissipate heat from inside the housing.

27. The electrophotographic image forming device as claimed in claim 26, wherein the metallic foam material is disposed above the one or more moving parts and is spaced apart therefrom.
